(19) United States
(12) Patent Application Publication
(10) Pub. No.: US 2008/0014375 A1
(43) Pub. Date: Jan. 17, 2008

(54) Display Panel, Liquid Crystal Display Device Including the Same and Method of Fabricating Liquid Crystal Display Device

(76) Inventor: Woo-Jin Bae, Seoul (KR)

Correspondence Address: Frank Chau, Esq.;F. CHAU & ASSOCIATES, LLC, 130 Woodbury Road, Woodbury, NY, 11797, US

(21) Appl. No.: 11/763,798

(22) Filed: Jun. 15, 2007

(30) Foreign Application Priority Data
Jul. 13, 2006 (KR) 10-2006-65991

(51) Int. Cl. C09K 19/02; B05D 5/12; B32B 9/04

(52) U.S. Cl. 428/1.5; 427/64; 428/411.1

(57) ABSTRACT

Disclosed are a display panel including a substrate and a shielding layer formed on the substrate, a liquid crystal display device including the same and a method of fabricating the liquid crystal display device. The shielding layer includes a clay-based material to block the passage of impurities and a conductive polymer material to diffuse static electricity within the shielding layer. The malfunctioning of the device induced by the contamination and static electricity due to the impurities is prevented by the shielding layer.

### CROSS-REFERENCE TO RELATED APPLICATION

This application claims priority from Korean Patent Application No. 2006-65991, filed Jul. 13, 2006, the disclosure of which is hereby incorporated by reference herein in its entirety.

### BACKGROUND OF THE INVENTION

1. Technical Field

The present disclosure relates to a display device displaying an image. More particularly, the present disclosure relates to a display panel provided in a display device, a liquid crystal display device including the display panel and a method of fabricating the liquid crystal display device.

2. Description of the Related Art

Display devices are generally classified based upon how they operate to display an image. For example, display devices are typically classified as one of the following: a liquid crystal display device, a plasma display device, and an organic electroluminescence display device. Also, a display device may be applied to various electronic products, such as, for example, a large-sized TV, a monitor of a notebook computer and a cellular phone.

The above-described display devices typically include a pair of substrates facing each other. For example, a liquid crystal display device includes two substrates facing each other and a liquid crystal layer having liquid crystal provided therebetween. Moreover, an electric field is applied onto the liquid crystal layer and the alignment of the liquid crystal is changed according to the application of the electric field to display a corresponding image externally.

During the fabricating process for the liquid crystal display device, or when the liquid crystal display device is used, static electricity may be generated. When the static electricity is inputted into the liquid crystal layer, the electric field may be affected, thereby possibly resulting in a malfunctioning of the liquid crystal display device. In addition, the liquid crystal display device may be easily contaminated by various impurities, thereby possibly leading to the deterioration of the image quality of the liquid crystal display device.

The above-mentioned malfunctioning difficulties may occur in other display devices in addition to the liquid crystal display devices because the space between two substrates of a display device may readily be exposed to static electricity or may be readily contaminated by foreign materials.

### SUMMARY OF THE INVENTION

Exemplary embodiments of the present invention provide a display panel capable of shielding static electricity and impurities.

Exemplary embodiments of the present invention provide a liquid crystal display device giving an improved quality image using the above-described display panel.

Exemplary embodiments of the present invention provide a method of manufacturing the liquid crystal display device.

In accordance with an exemplary embodiment of the present invention, a display panel is provided. The display panel includes a substrate used for the display device and a shielding layer formed on the substrate to shield impurities and static electricity from the substrate. The shielding layer includes a clay-based material to shield a passage of the impurities and includes a polymer material having the following chemical formula:

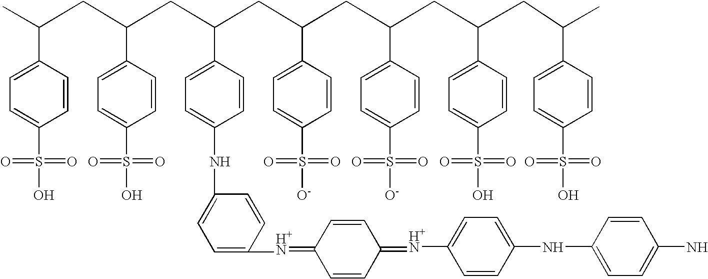

and wherein the polymer material also has conductivity to diffuse the static electricity within the shielding layer

In accordance with an exemplary embodiment of the present invention, a liquid crystal display device is provided. The liquid crystal display device includes a first and a second substrate, a first and a second alignment layer, a liquid crystal layer and a shielding layer. The first and the second substrate face each other. The first and the second alignment layer, respectively is formed on the first and the second substrate. The liquid crystal layer is formed between the first and the second substrate. The shielding layer is formed at least one of the following of between the first substrate and the first alignment layer and between the second substrate and the second alignment layer, and shields an inflow of impurities and static electricity into the liquid crystal layer. The shielding layer includes a clay-based material to shield a passage of the impurities and a polymer material having conductivity to diffuse the static electricity within the shielding layer.

In accordance with another exemplary embodiment of the present invention, a method of manufacturing a liquid crystal display device is provided. The method includes the following steps set forth below. A first and a second substrate are prepared. A first alignment layer is formed on the first substrate. A second alignment layer is formed on the second substrate. The first and the second substrate are attached together and a liquid crystal layer is formed between the substrates. During preparing the first and the second substrate, at least one shielding layer is formed on at least one of the first or the second substrate to shield an inflow of impurities and static electricity into the liquid crystal layer. The shielding layer includes a clay-based material to shield a passage of the impurities and includes a polymer material having conductivity to diffuse the static electricity within the shielding layer and an aqueous polyaniline graft copolymer obtained by grafting aniline monomer onto the main chain of polystyrene sulfonic acid.

The shielding layer may be formed by the following steps. The polymer material is dissolved into an aqueous solution. A clay-based material is mixed with the aqueous solution. A curing agent is added into the mixture solution. The mixture solution including the curing agent is coated on one of the substrate of the first and the second substrate.

According to the above-mentioned exemplary embodiments, the shielding layer blocks the static electricity and the impurities to accomplish a high quality image.

### BRIEF DESCRIPTION OF DRAWINGS

Exemplary embodiments of the present invention can be understood in more detail from the following detailed description taken in conjunction with the accompanying drawings, in which:

FIG. 1 is a cross-sectional view of a display panel according to an exemplary embodiment of the present invention;

FIGS. 2A and 2B are cross-sectional views illustrating a procedure of preventing of a malfunction due to static electricity through the shielding layer in FIG. 1;

FIGS. 3A to 3C are views illustrating a procedure of preventing contamination due to foreign materials through the shielding layer in FIG. 1;

FIG. 4A is a planar view of a liquid crystal display device according to an exemplary embodiment of the present invention;

FIG. 4B is a cross-sectional view taken along line I-I′ of FIG. 4A;

FIGS. 5A and 5B are graphs illustrating conductivity characteristic of a shielding layer of FIG. 4B according to the composition of polymer material;

FIGS. 6A to 6F are cross-sectional views explaining a fabricating process of the liquid crystal display device illustrated in FIG. 4B; and

FIGS. 7A-7E are illustrated explaining the fabricating process of the first shielding layer in FIG. 6B.

### DETAILED DESCRIPTION OF THE EXEMPLARY EMBODIMENTS OF THE INVENTION

Hereinafter, exemplary embodiments of the present invention will be described in detail with reference to the attached drawings. However, the present invention is not limited to the following exemplary embodiments but includes various applications and modifications. In addition, the size of the layers and regions of the attached drawings along with the following embodiments are simplified or exaggerated for precise explanation or emphasis and the same reference numeral represents the same component.

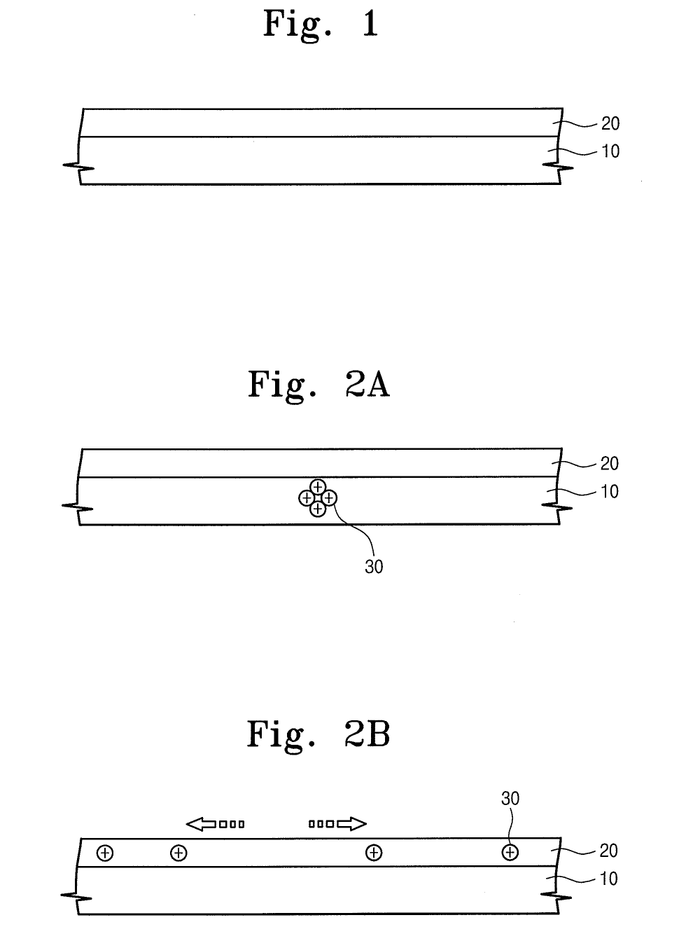

FIG. 1 is a cross-sectional view of a display panel according to an exemplary embodiment of the present invention.

Referring to FIG. 1, a substrate 10 and a shielding layer 20 are provided. The substrate 10 is included in a display device. When the display device is a liquid crystal display device, a transparent insulating substrate formed by using glass or plastic material is used. The display device includes a first substrate that externally displays an image and a second substrate facing the first substrate displaying the image. The substrate 10 may be one of the first and second substrates.

The shielding layer 20 includes a polymer material and a clay-based material dispersed onto the polymer material. The shielding layer 20 prevents the malfunctioning of the display device due to static electricity and impurities through the polymer material and the clay-based material.

FIGS. 2A and 2B are cross-sectional views explaining a mechanism of preventing the malfunctioning due to the static electricity through the shielding layer in FIG. 1.

Referring to FIG. 2A, the static electricity is generated at a certain region of the substrate 10 and a large amount of charges 30 come into the substrate 10. The static electricity is generated through various factors. For example, when a user presses the screen of a display device used as the monitor of a computer, the static electricity is generated and inflows into the substrate 10.

For the liquid crystal display device, the static electricity might be generated during the fabricating thereof as follows. During fabricating the liquid crystal display device, a polarizing plate is attached to the substrate 10. The polarizing plate is transferred with a protecting film attached thereon and then is attached to the substrate 10 after separating the protecting film. During separating the protecting film, the static electricity is generated and a large amount of charges 30 due to the static electricity inflows from the polarizing plate to the substrate 10. The charges 30 form unnecessary electric fields to induce the malfunctioning of the display device.

Referring to FIG. 2B, the charges 30 diffuse within the shielding layer 20 and cannot move out of the shielding layer 20 because of a conductive polymer material included in the shielding layer 20. That is, the shielding layer 20 exhibits a designated conductivity because of the conductive polymer material and so, the charges 30 move within the shielding layer 30 to diffuse. The charges 30 could not move out of the shielding layer 20 or into neighboring other layers and so, the charges 30 are substantially limited within the shielding layer 20. Accordingly, the malfunctioning of the display device due to the charges 30 of the static electricity can be prevented.

The conductive polymer material included in the shielding layer 20 is, for example, a graft copolymerizing product obtained by grafting the main chain of polystyrene sulfonic acid with aniline monomers. That is, the shielding layer 20 includes, for example, aqueous polystyrene sulfonic acid graft polyaniline (polystyrene sulfonic acid-g-polyaniline; which will be referred to by ‘PSSA-g-PANI’ hereinafter) represented by the following chemical formula 1.

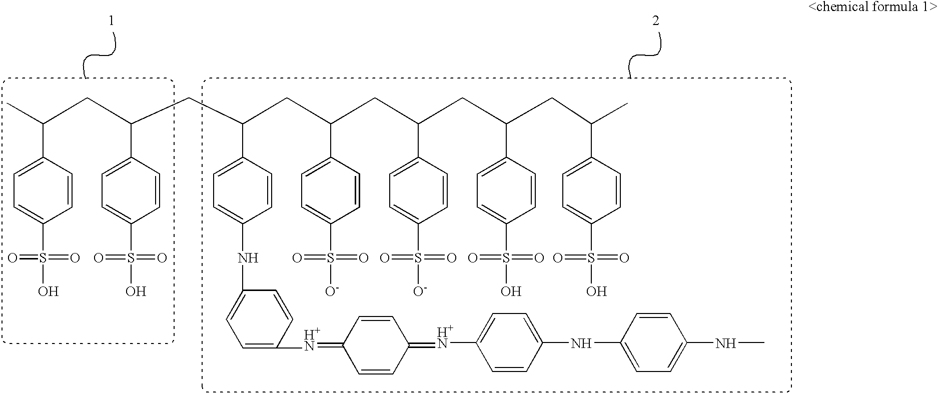

In PSSA-g-PANI, the main chain of polystyrene sulfonic acid includes a first portion (1) which is not concerned with polyaniline and a second portion (2) which is concerned with polyaniline. The first portion (1) is aqueous because of styrene sulfonic acid which is not concerned with polyaniline. For the second portion (2), hydrogen combined with nitrogen in a portion of an aniline functional group provides electrons to oxygen combined with sulfur included in sulfonic acid to exhibit a polarized state to show the conductivity. Accordingly, when the shielding layer 20 is formed by using PSSA-g-PANI, the shielding layer 20 can be formed using an aqueous solution because of the first portion (1) and the shielding layer 20 can exhibit the conductivity because of the second portion (2).

The shielding layer 20 may further include, for example, a trace amount of ethyl tri-methoxy silane represented by the following chemical formula 2.

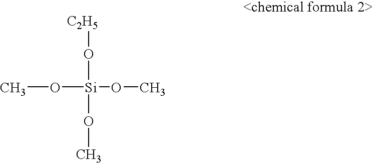

Also, the shielding layer 20 may further include, for example, a trace amount of tetra-ethyl ortho-silicate represented by the following chemical formula 3.

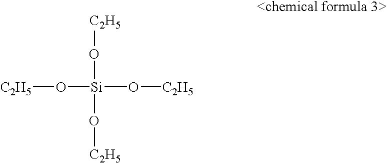

Ethyl tri-methoxy silane and tetra-ethyl ortho-silicate function as a curing agent that cures the aqueous solution state of the shielding layer 20 to a solid state layer.

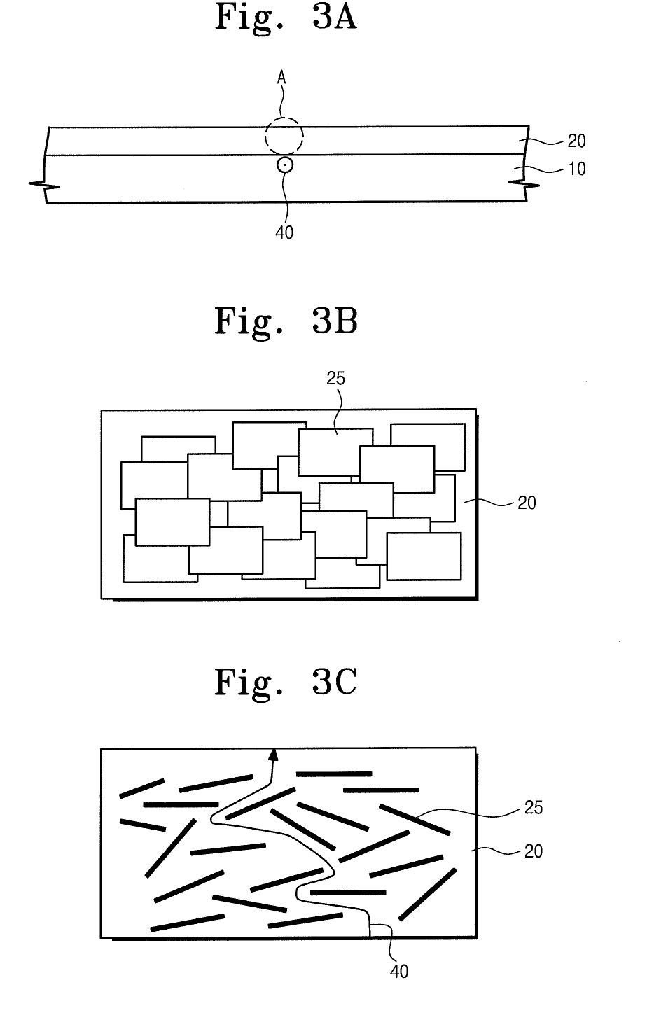

FIGS. 3A to 3C are views illustrating a mechanism of preventing contamination due to impurities through the shielding layer in FIG. 1.

Referring to FIG. 3A, an impurity 40 is generated at a certain region of the substrate 10 and moves to the shielding layer 20. The impurity 40 is generated through various factors, for example, the impurity 40 inflows from the exterior portion of the substrate 10 or is generated as a by-product during processing with respect to the substrate 10. For example, a liquid crystal display device includes a layer including photoresist such as a color filter and an over-coating layer. The photoresist includes, for example, a polymer resin, an organic solvent and a photoactive compound reactive to light, and the impurity can be generated from these complex compounds. The impurity can be a gas state, a liquid state or a solid state.

FIG. 3B is an enlarged planar view for the portion ‘A’ in FIG. 3A and FIG. 3C is an enlarged cross-sectional view for the portion ‘A’ in FIG. 3A.

Referring to FIG. 3B, the shielding layer 20 includes, for example, a clay-based material and the clay-based material includes a plurality of layers 25 having a plate-shaped structure. The plate-shaped layers 25 are separated from each other and are dispersed in the conductive polymer material included in the shielding layer 20. As the plate-shaped layers 25 have a thickness of about 1 nanometer (nm) and are dispersed in the conductive polymer material, the conductive polymer material and the clay-based material constitute a polymer-clay nano complex.

Referring to FIG. 3C, the plate-shaped layers 25 dispersed within the shielding layer 20 inhibit the movement of impurities 40. The passage of the impurities 40 through the shielding layer 20 is blocked by the plate-shaped layers 25 and a trace amount of the impurities 40 is liable to pass. Therefore, the malfunctioning of the display device due to the impurities 40 can be prevented.

The clay-based material includes various inorganic cations such as, for example, sodium cation (Na⁺), magnesium cation (Mg²⁺), calcium cation (Ca²⁺), and the like and the plate-shaped layers 25 can be integrated strongly through an electrostatic combination with the inorganic cations. For example, the clay-based material includes at least one of montmorillonite, bentonite, hectorite, fluorohectorite, saponite, beidelite, nontronite, stevensite, vermiculite, volkonskoite, magadite and kenyalite.

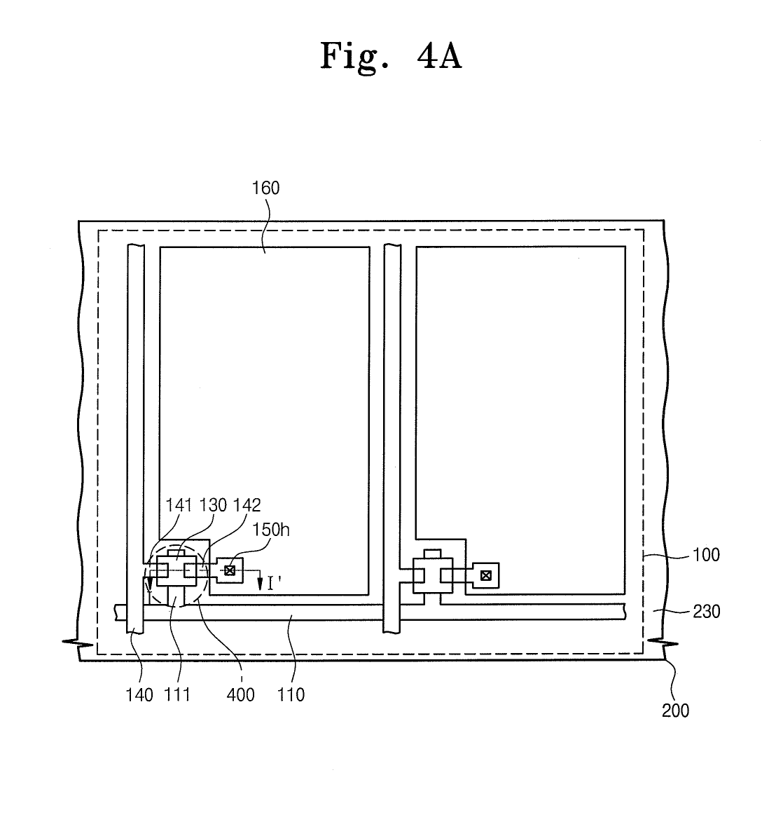

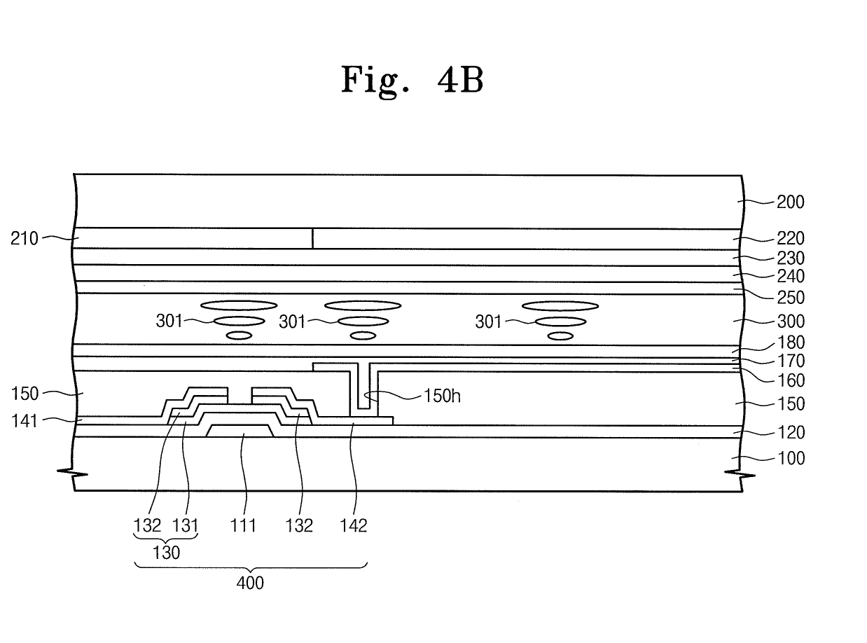

FIG. 4 is a planar view of a liquid crystal display device according to another exemplary embodiment of the present invention.

Referring to FIG. 4A, a first and second substrates 100 and 200 facing each other are provided. On the first substrate 100, gate lines 110 along the row direction and data lines 140 along the column direction cross each other while keeping an insulating state. The gate lines 110 and the data lines 140 define pixel areas by crossing each other. All of the pixel areas have the same structure.

At each pixel area, a thin film transistor 400 and a pixel electrode 160 are formed. The thin film transistor 400 includes a gate electrode 111, a source electrode 141 and a drain electrode 142. The gate electrode 111 is branched from the gate line 110. The source electrode 141 is branched from the data line 140. The drain electrode 142 faces the source electrode 141 and is electrically connected to the pixel electrode 160. The pixel electrode 160 occupies most of the region of the pixel area except the thin film transistor 400.

On the second substrate 200, a common electrode 230 corresponding to the pixel electrode 160 is formed. The pixel electrode 160 and the common electrode 230 have an interaction and form an electric field between the first and the second substrates 100 and 200.

FIG. 4B is a cross-sectional view taken along the line I-I′ in FIG. 4A.

Referring to FIG. 4B, the gate electrode 111 is formed on the first substrate 100. On the gate electrode 111, a gate insulating layer 120 is formed and the gate insulating layer 120 covers the whole surface of the first substrate 100. On the gate insulating layer 120, a semiconductor pattern 130 is formed. The semiconductor pattern 130 includes an active pattern 131 formed in one body and ohmic contact pattern 132 separated into two. On the semiconductor pattern 130, a source electrode 141 and a drain electrode 142 are formed. The source electrode 141 and the drain electrode 142 are facing and separated from each other. The active pattern 131 is exposed between the source electrode 141 and the drain electrode 142. The exposed region of the active pattern 131 corresponds to a channel region forming a channel during operating the thin film transistor 400.

On the source electrode 141 and the drain electrode 142, a passivation layer 150 to protect the channel region is formed. At the passivation layer 150, a contact hole 150h exposing a portion of the drain electrode 142 is formed. On the passivation layer 150, the pixel electrode 160 is formed and the pixel electrode 160 is electrically connected to the drain electrode 142 through the contact hole 150h. On the pixel electrode 160, a first shielding layer 170 and a first alignment layer 180 are formed.

On the second substrate 200, a light shielding pattern 210 and a color filter 220 are formed. The light shielding pattern 210 is formed to cover the regions corresponding to the boundary of the pixel regions and the thin film transistor 400. Except the covered regions, the light shielding pattern 210 is opened. The light shielding pattern 210 blocks the transmission of the light not controlled at the pixel electrode 160. The color filter 220 is formed to fill the opened region of the light shielding pattern 210. The color filter 220 includes blue/red/green filters corresponding to the three primary colors of light to display color image. On the color filter 220, an over-coating layer is formed to protect the color filter 220 and to planarize the second substrate 200.

On the color filter 220 or the over-coating layer, the common electrode 230 is formed. On the common electrode 230, a second shielding layer 240 and a second alignment layer 250 are formed. Between the first and the second alignment layers 180 and 250, a liquid crystal layer 300 in which liquid crystal 301 is aligned is provided. The initial alignment direction of the liquid crystal 301 can be controlled by the first and the second alignment layers 180 and 250.

During the operation of the liquid crystal display device, when a gate on signal is applied to the gate line 110, the thin film transistor 400 is turned on. Into the data line 140, data signals according to the image information is transferred and applied to the pixel electrode 160. At the same time, a common voltage is applied to the common electrode 230. An electric field according to the applied voltage difference between the pixel electrode 160 and the common electrode 230 is generated and functions onto the liquid crystal layer 300. The liquid crystal 301 has a dielectric anisotropy and the alignment direction of the liquid crystal 301 is changed according to the electric field. The liquid crystal 301 has a refractive anisotropy and a light transmitting the liquid crystal 301 exhibits transparency corresponding to the alignment direction of the liquid crystal 301 to display an image.

During operation, the liquid crystal layer 300 is exposed to various impurities and can be contaminated. When the liquid crystal 301 is contaminated, the quality of the externally displaying image during the operation of the liquid crystal display device can be deteriorated. One of the factors which may cause contamination of the liquid crystal 301 is the color filter 220. The color filter can be formed, for example, by patterning color photoresist including a pigment. As described above, the photoresist may include various chemical components such as, for example, a polymer resin, an organic solvent and a photoactive compound and so the impurities can be originated from the photoresist.

The first and the second shielding layers 170 and 240 includes, for example, the clay-based material having the plate-shaped layers, and the plate-shaped layers are distributed and dispersed within the first and the second shielding layers 170 and 240. The plate-shaped layers block the movement of the impurities and prevent the contamination of the liquid crystal 300 due to the passage of the impurities through the first and the second shielding layers 170 and 240. As described above, the clay-based material may be prepared by using various mineral including, for example, montmorillonite and can include an inorganic cation such as a sodium ion.

During the operation of the liquid crystal display device, static electricity might be generated and a large amount of charges from the first and the second substrates 100 and 200 might inflow into the liquid crystal layer 301. When the charges inflow, the electric field applied to the liquid crystal layer 301 might be changed to thereby cause malfunctioning of the liquid crystal display device.

The first and the second shielding layers 170 and 240 include a conductive polymer material, and the charges inflowing due to the static electricity diffuse within the shielding layers. As the result, the charges are present within the first and the second shielding layers 170 and 240 and cannot move to the liquid crystal layer 300. As explained above, the conductive polymer material includes an aqueous polyaniline graft copolymer produced by grafting the main chain of polystyrene sulfonic acid with an aniline monomer. That is, the polymer material include, for example, PSSA-g-PANI represented by chemical formula 1.

When the thickness of the first and the second alignment layers 180 and 250 are too thick, the intensity of the electric field functioning from the pixel electrode 160 and the common electrode 230 to the liquid crystal 301 might be weakened. In addition, when the thickness of the first and the second alignment layers 180 and 250 is too thick, a uniform thickness may not be accomplished and the uniform alignment of the liquid crystal 301 may not be accomplished. Considering this point, the preferred thickness of the first and the second alignment layers 180 and 250 may be about 1000 angstroms (Å). For example, the thickness of the first and the second shielding layers 170 and 240 corresponding to the first and the second alignment layers 180 and 250 may be from about 500 Å to about 2000 Å.

Both of the first and the second shielding layers 170 and 240 need not to be formed together, but one of the first and the second shielding layers 170 and 240 can be formed if necessary. For example, when considering the contamination of the liquid crystal display device due to the impurities mainly caused by the color filter 222 formed on the second substrate 200, the first shielding layer 170 can be omitted and only the second shielding layer 240 can be formed.

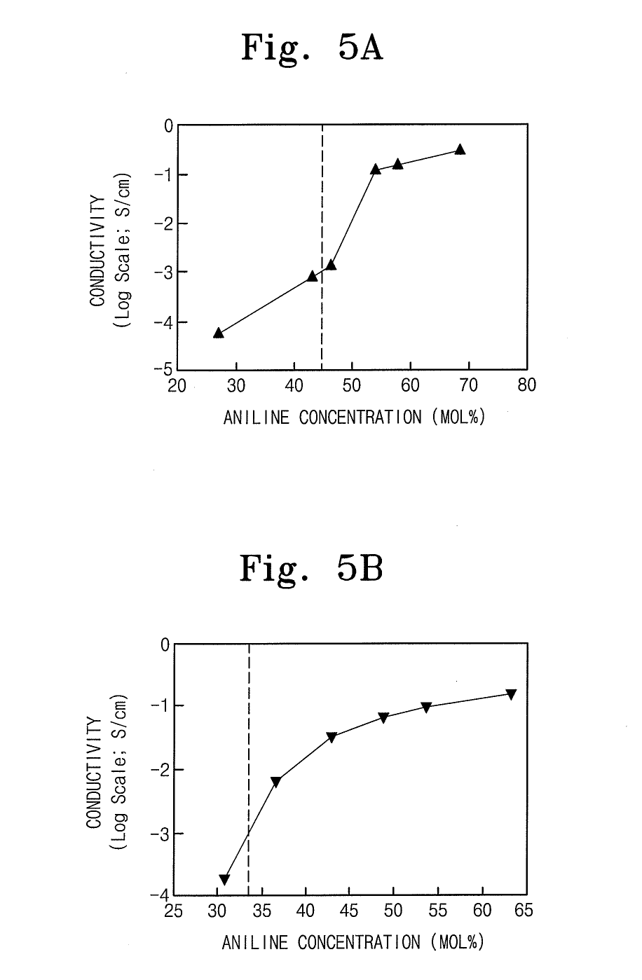

FIGS. 5A and 5B are graphs illustrating the conductivity characteristic according to the compositions of the polymer material in the shielding layer in FIG. 4B.

PSSA-g-PANI included in the first and the second shielding layers 170 and 240 can be prepared through, for example, a reaction of a copolymer of styrene sulfonic acid and aminostyrene with aniline. FIG. 5A and FIG. 5B, respectively, is obtained when the amount of aminostyrene included in the copolymer of styrene sulfonic acid and aminostyrene is about 1.2 mol % and about 8.0 mol %. In FIGS. 5A and 5B, the horizontal line represents the mol % of aniline reacting with the copolymer of styrene sulfonic acid and aminostyrene and the vertical line represents the conductivity according to the amount of the reacting aniline.

Referring to FIGS. 5A and 5B, the conductivity is increased as the amount of the reacting aniline increases. However, the amount of reacting aniline, which is required to obtain a predetermined degree of conductivity, for example, the conductivity of about 10⁻³ S/cm, is different as about 45 mol % and about 34 mol %, respectively.

As described above, in manufacturing PSSA-g-PANI, the conductivity can be controlled, for example, by controlling the amount of aminostyrene in the copolymer of styrene sulfonic acid and aminostyrene or by controlling the amount of reacting aniline with the copolymer of styrene sulfonic acid and aminostyrene. For example, the conductivity of the shielding layer which may prevent the malfunctioning of the liquid crystal display device due to generated static electricity is about 10⁻⁹ S/cm to about 10⁻¹ S/cm.

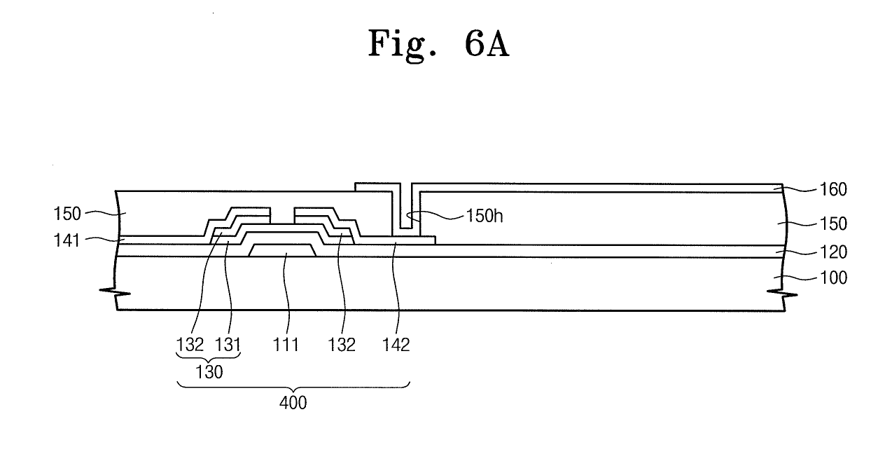

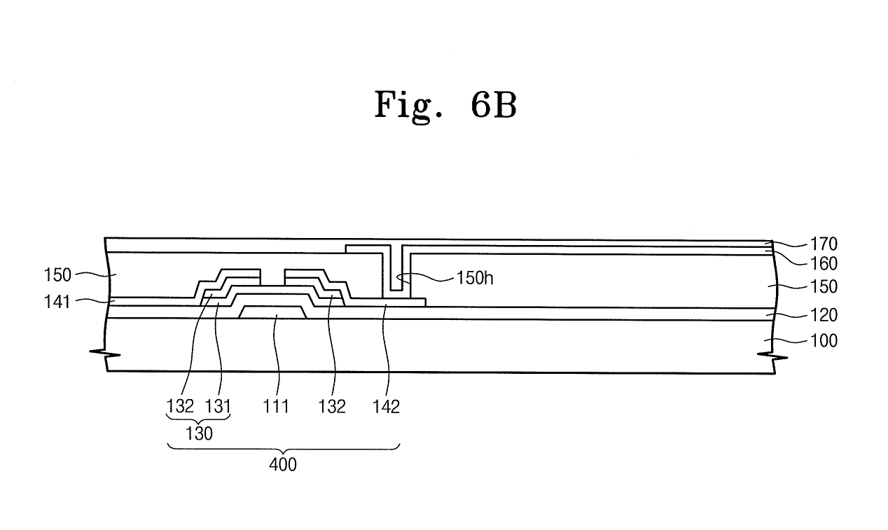

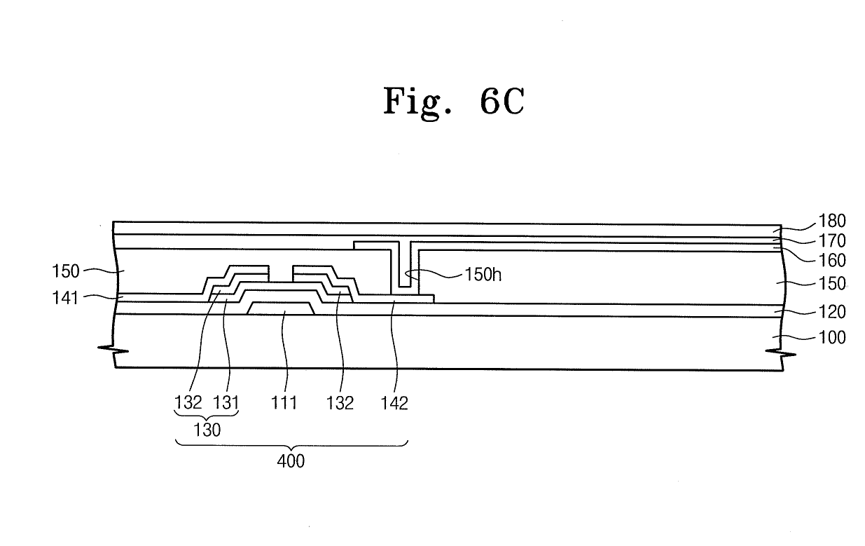

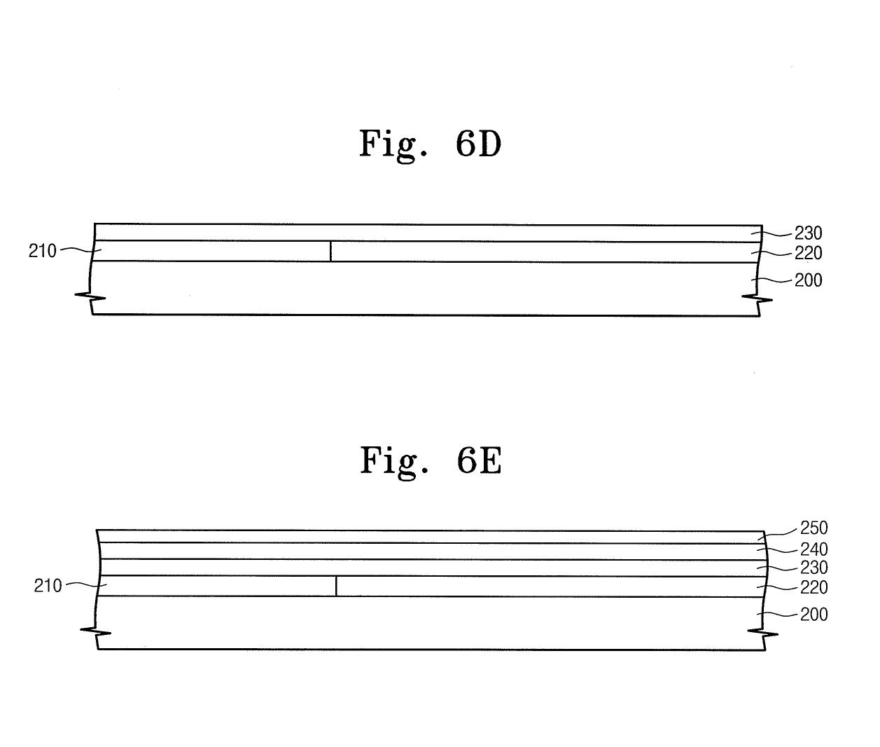

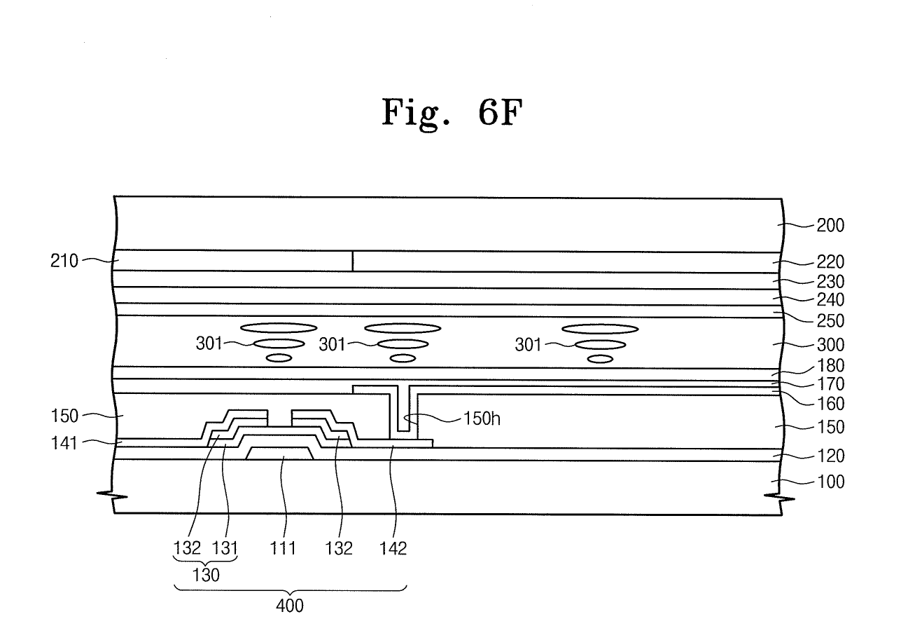

FIGS. 6A to 6F are cross-sectional views explaining a manufacturing process of the liquid crystal display device illustrated in FIG. 4B.

Referring to FIG. 6A, a gate electrode 111 is formed by forming a conductive layer on a first substrate 100 and then patterning the same. On the gate electrode 111, a gate insulating layer 120 and a semiconductor layer are formed by, for example, using a plasma chemical vapor deposition method. The semiconductor layer is patterned to form a semiconductor pattern 130. On the semiconductor pattern 130, a data conductive layer is formed and then is patterned to form a source electrode 141 and a drain electrode 142. The semiconductor pattern 130 includes an active pattern 131 and an ohmic contact pattern 132 and the ohmic contact pattern 132 is additionally etched to be separated along the source electrode 141 and the drain electrode 142.

On the source electrode 141 and the drain electrode 142, a passivation layer 150 is formed by applying the same method of forming the gate insulating layer 120. The passivation layer 150 is patterned to form a contact hole 150h exposing the drain electrode 142. On the patterned passivation layer 150, a transparent conductive layer utilizing, for example, indium zinc oxide (IZO) or indium tin oxide (ITO) is deposited and then is patterned to form a pixel electrode 160.

Referring to FIG. 6B, a first shielding layer 170 is formed on the pixel electrode 160. The first shielding layer 170 is formed, for example, by coating an aqueous state material onto the whole surface of the first substrate 100 by a spin coating method. The formation of the first shielding layer 170 will be described in detail below.

Referring to FIG. 6C, a first alignment layer 180 is formed on the first shielding layer 170. The first alignment layer 180 is formed, for example, by using a polyimide-based polymer compound having a good orientation stability, durability and productivity. The polyimide-based compound is coated as a diluted solution state of a low concentration on the first shielding layer 170 by, for example, a spin coating method or a printing method. The first alignment layer 180 is formed after evaporating the liquid components through, for example, a heat treatment.

Referring to FIG. 6D, a light shielding pattern 210 and a color filter 220 are formed on the second substrate 200. The light shielding pattern 210 is formed, for example, by coating a light shielding layer of photoresist on the second substrate 200 and then patterning the light shielding layer. The light shielding layer is exposed and developed during the patterning process and the light shielding layer corresponding to the pixel area is removed during the developing process.

The color filter 220 is formed by coating color photoresist on the second substrate 200 and then patterning the color photoresist layer. The color filter 220 fills the region where the light shielding layer is removed through the patterning of the light shielding layer. The patterning with respect to the color photoresist layer is implemented three times for red/green/blue. A transparent layer is deposited on the color filter 220 to form a common electrode 230.

Referring to FIG. 6E, a second shielding layer 240 and a second alignment layer 250 are formed on the common electrode 230. The second shielding layer 240 is formed by applying the same method of forming the first shielding layer and the second alignment layer 250 is formed by applying the same method of forming the first alignment layer 180.

Referring to FIG. 6F, a liquid crystal layer 300 is formed between the first substrate 100 and the second substrate 200. The liquid crystal layer 300 can be formed, for example, by an injection method or a dropping method. The first and the second substrates 100 and 200 are arranged to face each other and be pressed and attached together.

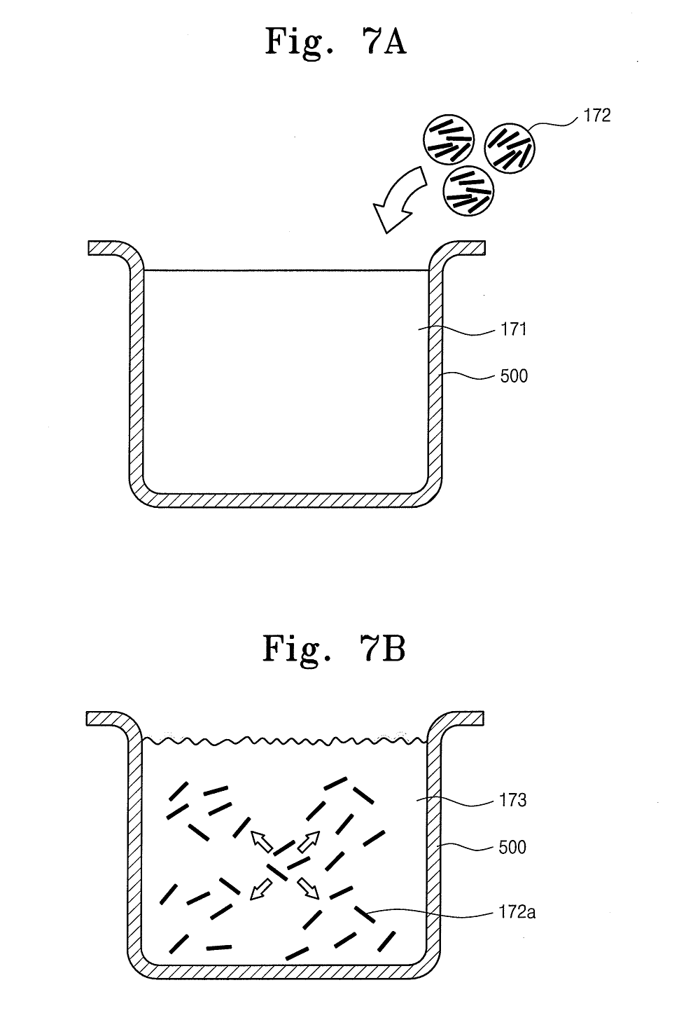

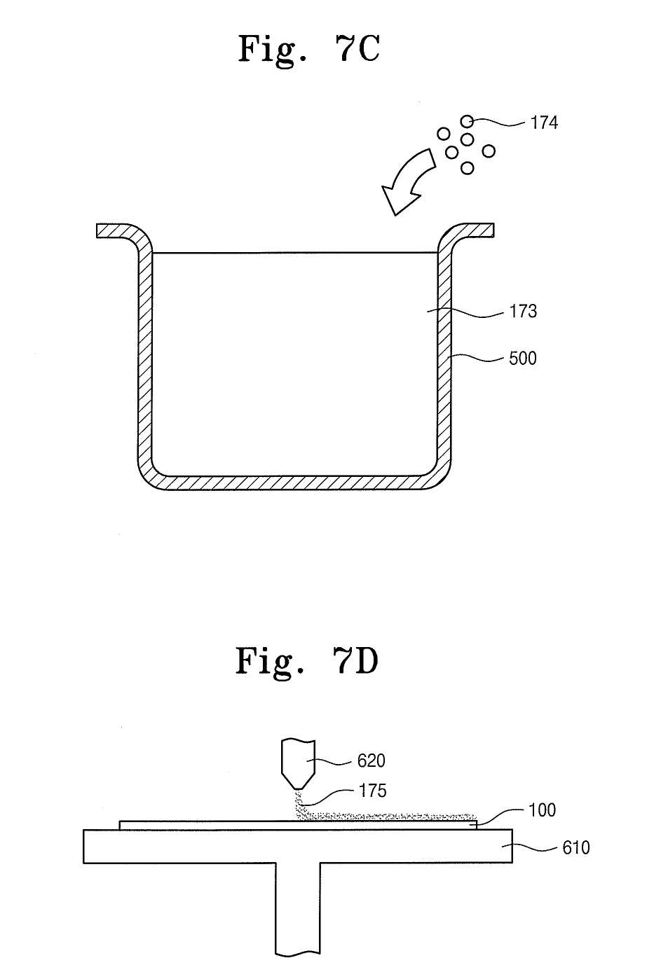

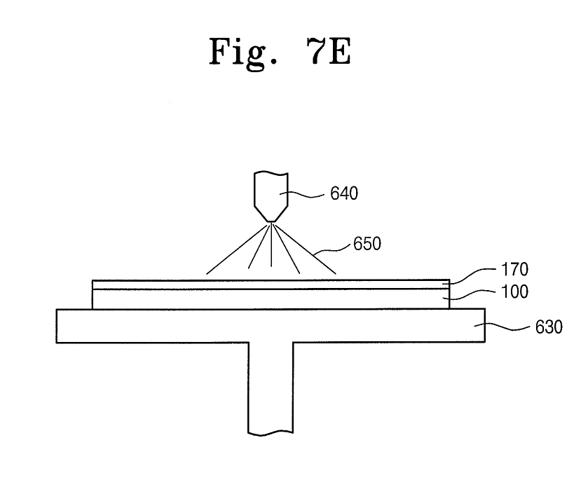

FIGS. 7A to 7E are views illustrating a manufacturing process of the first shielding layer in FIG. 6B.

Referring to FIG. 7A, a clay-based material 172 is added into a container 500 containing an aqueous solution of a polymer material 171 and then mixed. As the polymer material, PSSA-g-PANI represented by chemical formula 1 is used. As described above, PSSA-g-PANI is aqueous due to styrene sulfonic acid. The clay-based material 172 may be prepared by using various minerals including, for example, montmorillonite and the like. In addition, the clay-based material 172 can include an inorganic cation such as, for example, a sodium cation. The clay-based material 172 is processed to be plate-shaped layers having a thickness of about 1 nm.

The clay-based material 172 is mixed by from about 5% to about 20% by weight with respect to the aqueous solution 171. When the amount of the clay-based material 172 is used too much, the physical property of the polymer material included in the aqueous solution 171 might be changed.

Referring to FIG. 7B, the mixture solution 173 is stirred to disperse the plate-shaped layers 172a included in the clay-based material into the mixture solution 173. As described above, the plate-shaped layers 172a are strongly integrated through an electrostatic combination with the inorganic cations and are not easily dispersed. At this time, an ultrasonic wave is applied to the mixture solution 173 to facilitate the dispersion of the plate-shaped layers 172a. The mixture solution 173 in which the plate-shaped layers 172a are dispersed can be used in various states. For example, a precipitate in the mixture solution 173 can be used or a solution state as follows can be used for the formation of a layer.

Referring to FIG. 7C, a trace amount of a curing agent 174 is added into the mixture solution 173. For example, as the curing agent 174, ethyl tri-methoxy silane or tetra-ethyl ortho-silicate represented by the chemical formula 2 or the chemical formula 3 can be used. The amount added of the curing agent 174 may be, for example, in the range of from about 0.2% to about 1% by weight based on the mixture solution 173.

Referring to FIG. 7D, the mixture solution 175 including the curing agent is coated on the first substrate 100. The first substrate 100 is safely fixed on a stage 610 and the mixture solution 175 including the curing agent is coated on the first substrate 100 by moving a dispenser 620. Various coating methods can be applied and for example, a rotating coating method by which the mixture solution 175 including the curing agent is coated on the first substrate 100 while rotating the first substrate 100, can be applied.

Referring to FIG. 7E, liquid components are evaporated from the mixture solution 175 including the curing agent through, for example, a heat treatment, a first shielding layer 170 is formed through the function of the curing agent. The first shielding layer 170 is washed by spraying a washing solution 650 to the first shielding layer 170 through a nozzle 640.

The second shielding layer 240 illustrated in FIG. 6E also can be formed by applying the same method explained referring to FIGS. 7A-7E.

According to exemplary embodiments of the present invention, a shielding layer is provided onto a substrate which may prevent the malfunctioning of a display device induced by a contamination due to impurities and static electricity.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed:

1. A display panel comprising:
a substrate used for the display device; and
a shielding layer formed on the substrate to shield impurities and static electricity from the substrate,
wherein the shielding layer includes a clay-based material to shield a passage of the impurities and includes a polymer material having the following chemical formula:. 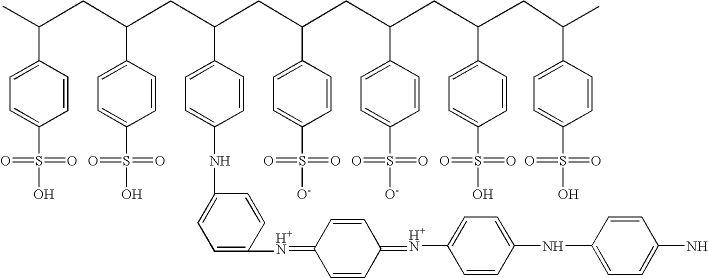
and wherein the polymer material also having conductivity to diffuse the static electricity within the shielding layer.

2. The display panel as claimed in claim 1, wherein the clay-based material includes a plurality of layers having a plate-shaped structure, the plate-shaped layers being separated from each other and being dispersed within the polymer material.

3. The display panel as claimed in claim 2, wherein the clay-based material is at least one selected from the group consisting of montmorillonite, bentonite, hectorite, fluorohectorite, saponite, beidelite, nontronite, stevensite, vermiculite, volkonskoite, magadite and kenyalite.

4. The display panel as claimed in claim 1, wherein the shielding layer further includes one of ethyl tri-methoxy silane and tetra-ethyl ortho-silicate.

5. A liquid crystal display device comprising:
a first and a second substrate facing each other;
a first and a second alignment layer, respectively formed on the first and the second substrate;
a liquid crystal layer formed between the first and the second substrate; and a shielding layer formed at least one of the following between the first substrate and the first alignment layer and between the second substrate and the second alignment layer, so as to shield an inflow of impurities and static electricity into the liquid crystal layer,
wherein the shielding layer includes a clay-based material to shield a passage of the impurities and a polymer material having conductivity to diffuse the static electricity within the shielding layer.

6. The liquid crystal display device as claimed in claim 5, wherein the clay-based material includes a plurality of layers having a plate-shaped structure, the plate-shaped layers being separated from each other and being dispersed within the polymer material.

7. The liquid crystal display device as claimed in claim 6, wherein the clay-based material is at least one selected from the group consisting of montmorillonite, bentonite, hectorite, fluorohectorite, saponite, beidelite, nontronite, stevensite, vermiculite, volkonskoite, magadite and kenyalite.

8. The liquid crystal display device as claimed in claim 5, wherein the polymer material includes an aqueous polyaniline graft copolymer obtained by grafting aniline monomer onto the main chain of polystyrene sulfonic acid.

9. The liquid crystal display device as claimed in claim 8, wherein the aqueous polyaniline graft copolymer has the following chemical formula:

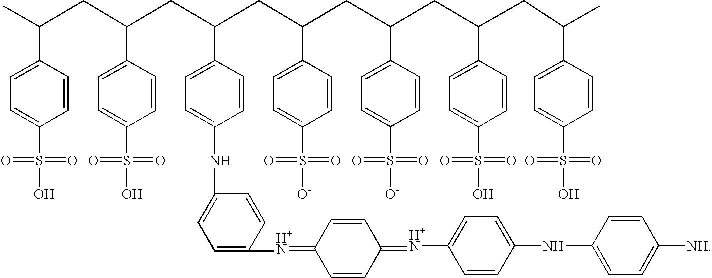

10. The liquid crystal display device as claimed in claim 5, wherein the shielding layer further includes one of ethyl tri-methoxy silane and tetra-ethyl ortho-silicate.

11. The liquid crystal display device as claimed in claim 5, wherein the shielding layer has a conductivity of from about 10⁻⁹ S/cm to about 10⁻¹ S/cm.

12. The liquid crystal display device as claimed in claim 5, wherein the shielding layer has a thickness in a range from about 500 angstroms (Å) to about 2000 Å.

13. A method of fabricating a liquid crystal display device, the method comprising:
preparing a first substrate and a second substrate; forming a first alignment layer on the first substrate;
forming a second alignment layer on the second substrate;
attaching the first and second substrates together; and
forming a liquid crystal layer between the first and the second substrates,
wherein the preparing of the first and second substrates includes forming a shielding layer on at least one of the following of the first or the second substrate to shield an inflow of impurities and static electricity into the liquid crystal layer, the shielding layer including a clay-based material to shield a passage of the impurities and including a polymer material having conductivity to diffuse the static electricity within the shielding layer and an aqueous polyaniline graft copolymer obtained by grafting aniline monomer onto the main chain of polystyrene sulfonic acid.

14. The method as claimed in claim 13, wherein the aqueous polyaniline graft copolymer has the following chemical formula:

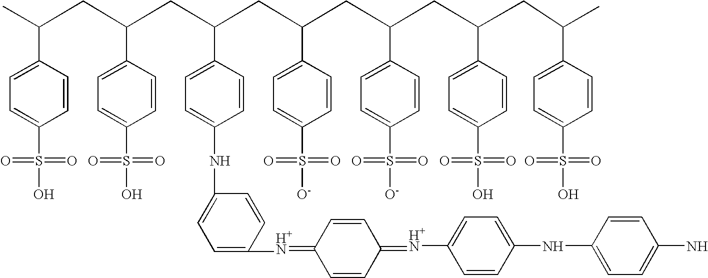

15. The method as claimed in claim 13, wherein the forming of the shielding layer comprises:
dissolving the polymer material into an aqueous solution;
mixing the clay-based material with the aqueous solution;
adding a curing agent into the mixture solution; and
coating the mixed solution including the curing agent onto one of the first and the second substrate.

16. The method as claimed in claim 15, wherein the clay-based material includes a plurality of layers having a plate-shaped structure, the method further comprising mixing the mixture solution and dispersing the plate-shaped layers by applying ultra sonic wave after mixing the clay-based material with the aqueous solution.

17. The method as claimed in claim 16, wherein the clay-based material is at least one selected from the group consisting of montmorillonite, bentonite, hectorite, fluorohectorite, saponite, beidelite, nontronite, stevensite, vermiculite, volkonskoite, magadite and kenyalite.

18. The method as claimed in claim 15, wherein an amount of the clay-based material mixed with respect to the aqueous solution is in a range from about 5% to about 20% by weight.

19. The method as claimed in claim 15, wherein the curing agent is one of ethyl tri-methoxy silane and tetra-ethyl ortho-silicate.

20. The method as claimed in claim 19, wherein an amount of the curing agent added to the mixture solution is in a range from about 0.2% to about 1% by weight.

21. The liquid crystal display of claim 5, wherein the shielding layer comprises a first shielding layer and a second shielding layer, and wherein the first shielding layer is located between the first substrate and the first alignment layer and the second shielding layer is located between the second substrate and the second alignment layer.
